(19) United States
(12) Patent Application Publication
(10) Pub. No.: US 2006/0230100 A1
(43) Pub. Date: Oct. 12, 2006

(54) Web content transcoding system and method for small display device

(76) Inventors: Hee Sook Shin, Taegu (KR); Dong Woo Lee, Taejon (KR); Pyeong Soo Mah, Taejon (KR); Bum Ho Kim, Seoul (KR); Soo Sun Cho, Taejon (KR); Dong Won Han, Taejon (KR); Eunjeong Choi, Kyungsangbook-Do (KR)

Correspondence Address: FLESHNER & KIM, LLP, P.O. BOX 221200, CHANTILLY, VA, 20153, US

(21) Appl. No.: 10/539,768

(22) PCT Filed: Oct. 31, 2003
(86) PCT No.: PCT/KR03/02322

§ 371 Date: Jun. 20, 2005

(30) Foreign Application Priority Data
Nov. 1, 2002 (KR) 10-2002-0067416

(51) Int. Cl. G06F 15/16

(52) U.S. Cl. 709/203

(57) ABSTRACT

Disclosed is a web content converting system and method for converting a large display screen web document into a small display screen web document. The system can include a preprocessor for standardizing a web document for analysis; a client profile analyzer for extracting and managing client information; a structure analyzer; and image converter for extracting information on an image encoding/de-coding procedure and an image size; a component block extractor for grouping the set content unit piece (component) to similar groups within a range not exceeding a maximal width; a component block categorizer for categorizing each of component block extractor into index and body content portions; an index generator; a voice markup generator; and a Hyper-Text Markup Language (HTML) generator.

### TECHNICAL FIELD

The present invention relates to a web content converting technology, and more particularly, to a web content transcoding (converting) system and method for a small display device in which a web document that is prepared suitable for a display performance of a general desktop personal computer can be converted to be effectively displayed even on a small display.

### BACKGROUND ART

Recently, as development of mobile communication and small device technologies are accelerated, a graft of these technologies on Internet forms a wireless Internet environment and begins to satisfy people's desires for intending to use a web anytime and anywhere. However, where web information over a wire internet is made adaptively to a display size of the desktop computer and is browsed through the small display device, a conventional art has a drawback in that the content information is not well displayed on the small display device due to its excess of the performance of the small display device.

In order to solve this drawback, various content converting methods have been proposed. However, since a simple converting into a text summary is a mainstream for initial methods for supporting a cellular phone series device or a low performance PDA (Personal Digital Assistant), etc., the user's requiring much information cannot be well displayed. This is caused by a limit to a device performance and a main use of a wireless Internet markup language with a simple expression capability such as a text or HDML. (Handheld Device Markup Language), WML (Wireless Markup Language), etc.

The conventional converting has a drawback in that since only a portion of the existing web information is extracted and converted, it is difficult to exactly convert a current complicate-structured web page having a lot of images and information simultaneously expressed.

After that, as devices of the high performance PDA, hand-held personal computer, etc. have appeared, converting methods therefor have been continuously studied. As a result, a converting tool that operates in a server such as WebSphere Converting Publisher, Sypglass, Prism, etc. manufactured by IBM has appeared. The converting tool uses a method in which a web server manager converts through its manual work so as to more exactly convert a web content. The converting tool has a disadvantage in that non-automatic converting is performed, and a converting-served document is limited in its range comparing with an enormous amount of the document on the wire Internet.

Further, as a converting method functioning in the device, there are Smart View, Pad++, etc. for providing a zoom-in/zoom-out function. The smart View, Pad++, etc. have and advantage in that a device performance can be more exactly understood and a user's requirement can be easily reflected, but have an inconvenience in that after general information on a total page is checked with the image, a zoomed-in content is once more again check for a substantial understanding of the content by using a zoom-in interface at each portion of the page.

Further, as the converting methods functioning at a proxy server, there are Top Gun Wingman that provides a converting proxy for a browser of a palmpilot device, and Digester that supports all of the handheld or cellular series devices, etc. The Digester performs the converting depending on various heuristic converting methods obtained through the converting directly performed by a person, and suitable application rules therefor. For exact converting, a plurality of complicated algorithms is used, and information on the converting result is expressed in summary, zoom-out or page division, etc. However, there is a drawback in that an interface is inconvenient for an information search due to a limited information expression method, a complicated category structure, and a use of a plurality of hyperlink indexes.

Other conventional arts are well known as disclosed in “Real-time internet content converting method and system” in Korean Patent Laid-Open No. 2002-31691 (Application No. 10-2000-0062342), and in “Content formulation system and method” in Korean Patent Laid-Open No. 2002-15223 (Application No. 10-2000-0048415). Herein, the “Real-time internet content converting method and system” uses a predetermined rule such that a portion of a document content is extracted, page-divided or converted into other markup languages. The converting into a document summary is merely performed and a document analysis method and a re-expression method are not disclosed in detail. Further, the “Content processing system and method thereof” merely refers to a general construction of a converting system for the small device user of a wire web content.

Accordingly, a conventional web document converting technique does not reflect a rapid improvement of the device performance, and means converting in a way of extraction of only a specific portion or a content summary, the complicated category structure for expressing this, and the page-division and link-connection. A detailed proposal cannot be found for a clearly analyzing, converting and expressing method. That is, in most of earlier studies, the simple text summarizing converting is performed for the low performance cellular phone series device. Recently, high performance hand-held devices have been appeared, but the converting for content reduction such as the content summary, the image deletion, etc. is still mainstream. Or, a method for the page-division and the page-link using link is provided, but in case a link depth is deepen even without a substantial content summary, there is an inconvenience in that a total content is difficult to be understood and a previous page is again returned.

### DISCLOSURE OF THE INVENTION

Accordingly, the present invention is directed to system and method for parsing multi-document based on elements, which substantially obviate one or more of the problems due to limitations and disadvantages of the related art.

Accordingly, the present invention is directed to a web content converting system and method for a small display device that substantially obviates one or more problems due to limitations and disadvantages of the related a rt.

An object of the present invention is to provide a web content converting system and method for a small display device in which a current web document including a lot of complicated information can be converted to reflect a content of an original document to the maximum and simultaneously to have a convenient interface, in consideration of a performance improvement of a user's device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a web content converting system for converting a large display screen web document into a small display screen web document, the system including: a preprocessor for standardizing a non-standard web document having an erroneous tag to output the standardized web document in a data format suitable for analysis; a client profile analyzer for extracting and managing client information; a structure analyzer for receiving the web document standardized in the preprocessor to set the web document to a content unit piece (component) according to a document analysis algorithm; an image converter for extracting information on an image encoding/decoding procedure and an image size included in the web document; a component block extractor for grouping the set content unit piece (component) to similar groups within a range not exceeding a maximal width by using an attribution value of the content unit piece (component) and client performance information; a component block categorizer for categorizing each of component blocks generated by the component block extractor into index and body content portions in accordance with a content characteristic; an index generator for extracting information on image or text index from the component block categorized into the index portion, and generating a script file and an additional tag collection for expressing the extracted information; a voice markup generator for converting a text-centered body content block into a voice markup language to perform a voice supporting function; and a HyperText Markup Language; (HTML) generator for rearranging and reconstructing the generated content object elements according to a document pattern to generate the small display screen web document.

In another aspect of the present invention, there is provided a web content converting method for converting a large display screen web document into a small display screen web document, the method including: a preprocessing step for standardizing a non-standard web document including an erroneous tag to output the standardized web document in a data format suitable for analysis; a web document analyzing step for receiving the standardized web document and analyzing a tag according to a document analysis algorithm to set the web document to a content unit piece (component); a component block setting step for grouping the set content unit piece (component) to similar groups within a range not exceeding a maximal width by using an attribution value of the content unit piece (component) and client performance information; a component block categorizing step for categorizing each of component blocks generated by the component block extractor into index and body content portions in accordance with a content characteristic; an index generating step for extracting information on image or text index from the component block categorized into the index portion, and generating a script file and an additional tag collection for expressing the extracted information; a voice markup generating step for converting a text-centered body content block into a voice markup language to perform a voice supporting function; and a HyperText Markup Language (HTML) generating step for rearranging and reconstructing the generated content object elements according to a document pattern to generate the small display screen web document.

According to the above construction and method, the present invention provides a convenient interface in which a characteristic of the web document is reflected for simultaneously expressing a lot of current complicated information through the rearrangement by the content unit block, not the conventional information extracting and summarizing method, and a visual and auditory expression is simultaneously supported without a left and right scroll through index generation and categorization of the content unit block, and the converting into a format of a voice supporting document, not a conventional method of an index-structure having more depths or page-division.

Accordingly, in the present invention, a total web document can be browsed without the left and right scroll through the rearrangement of the content unit block, the extraction of the index block and various index generating functions considering a screen content of the original web document can be reflected to the maximum by constructing a total structure suitably for a small screen size.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exemplary view illustrating a web document for expressing content blocks different from one another through visual categorizing and grouping;

FIG. 2 is a conceptive view illustrating a module construction of a web content converting system for a small display device according to a preferred embodiment of the present invention;

FIG. 3 is a view illustrating an expression class relation of a table tag;

FIG. 4 is a flow chart illustrating an operational procedure of a web content converting system for a small display device according to a preferred embodiment of the present invention;

FIG. 5 is a flow chart of illustrating a detailed algorithm of a web document analyzing step of FIG. 4;

FIG. 6 is a flow chart of illustrating a detailed algorithm of a component block setting step of FIG. 4;

FIGS. 7A and 7B are exemplary views for describing a web document analyzing step and a component block extracting step according to a preferred embodiment of the present invention;

FIG. 8 is a flow chart illustrating a detailed algorithm of a component block categorizing step of FIG. 4;

FIGS. 9A and 9B are exemplary views illustrating a converting result of a web content according to a preferred embodiment of the present invention.

### BEST MODE FOR CARRYING OUT THE INVENTION

Reference will now be prepared in detail to the preferred embodiments of the present invention, examples of which are illustrated in the accompanying drawings. Wherever possible, the same reference numbers will be used throughout the drawings to refer to the same or like parts.

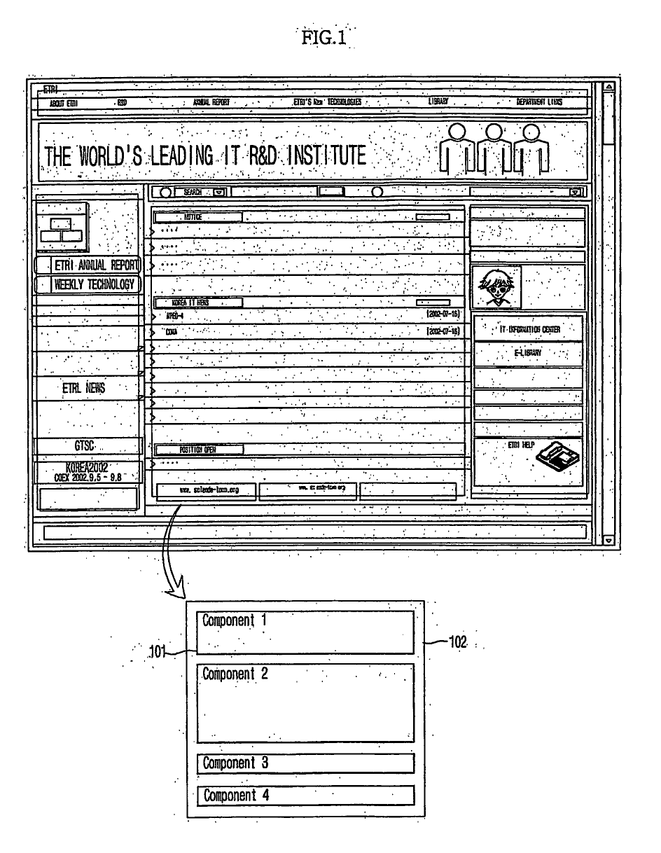

FIG. 1 is an exemplary view illustrating a web document for expressing content blocks different from one another through visual categorizing and grouping.

Referring to FIG. 1, the web document is designed for visual categorization of a content having a meaningful difference using a layout and a structural tag such that a manufacturer of a HTML (HyperText Markup Language) clearly transmits the content. Most of the visual categorizations use the tag for a structural expression such as “TABLE”, etc., and accordingly, the tags can be analyzed to understand a total structure. At this time, some injudicious use of a tag collection and an unclear categorization in a structure and a meaning of the HTML itself are considered to utilize an attribution value of the tag, a data characteristic of the tag, and position information for expressing data information of the tag object, etc. as well as the structural tag, for analysis.

Through the structure analysis of the web document, a minimal content unit piece 101 (it is called “component”) constructing a visual categorization layout as shown in FIG. 1 is set, and the content unit piece 101 is grouped considering a performance, particularly a display performance of the user device, and is expressed as a content unit block (it is called “component block”) 102.

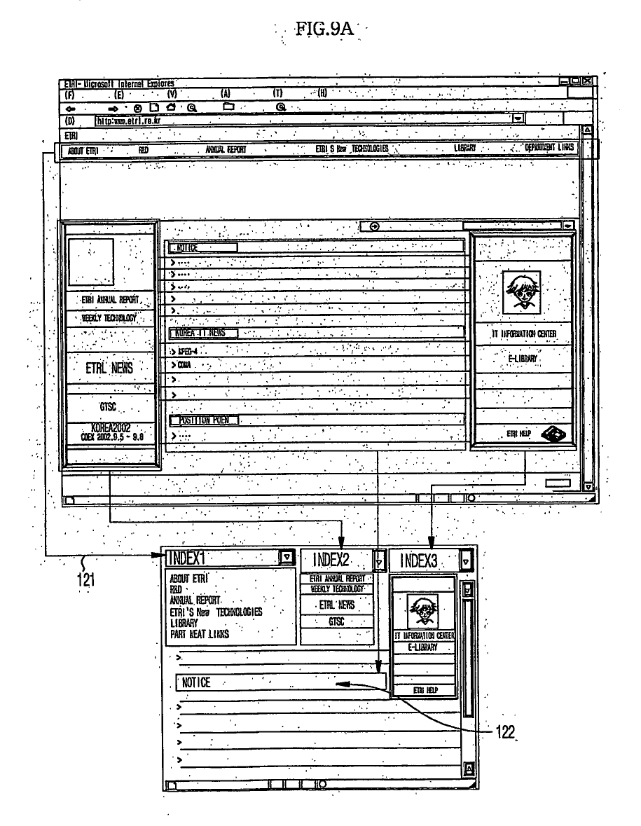

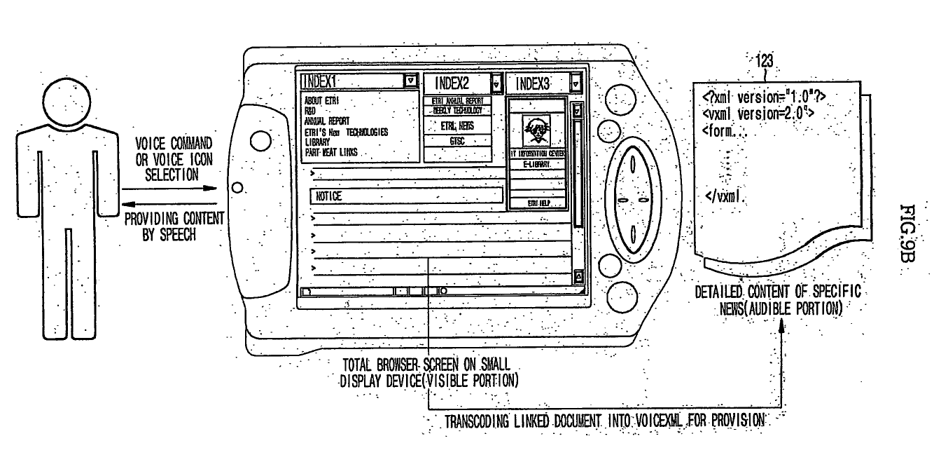

The content unit blocks 102 are categorized into an “index” portion and a “content body” portion according to a characteristic of the content, and are respectively re-expressed in a suitable format. The index portion is re-expressed in a format of an upper selected box as shown in 121 of FIG. 9A, which will be described later, and the body portion is merely rearranged without any converting into a main content portion as shown in 122 of FIG. 9A or converted into a voice supportable document format as shown in 123 of FIG. 9B for expression.

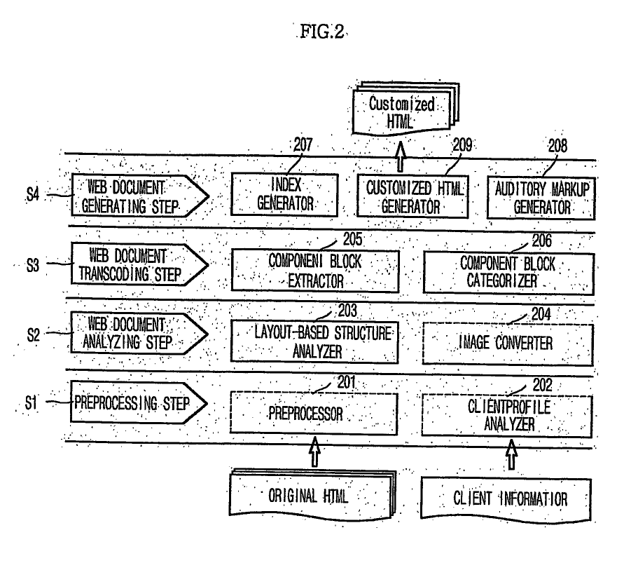

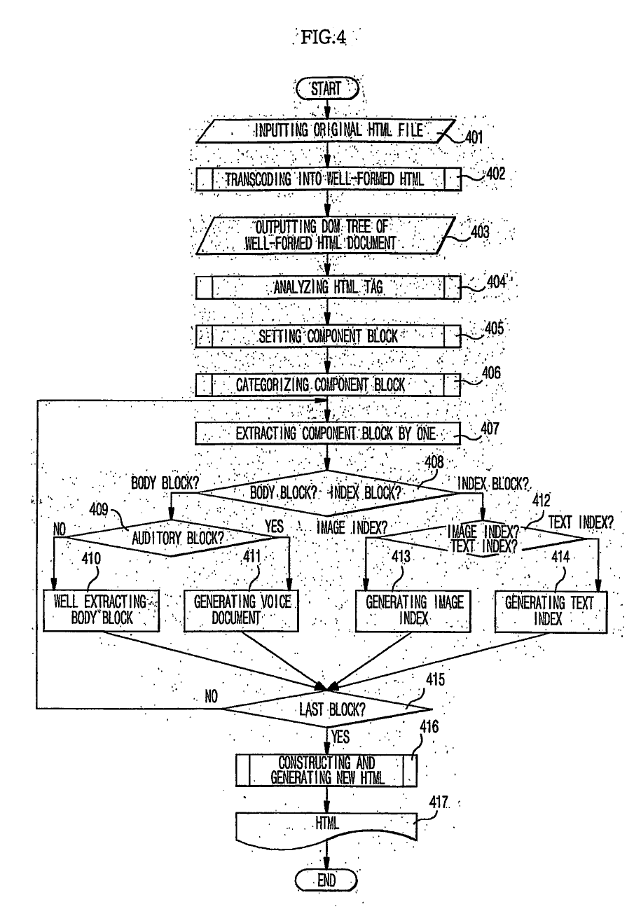

FIG. 2 is a conceptive view illustrating a module construction of a web content converting system for a small display device according to a preferred embodiment of the present invention, and FIG. 4 is a flow chart illustrating an operational procedure of the web content converting system for the small display device according to a preferred embodiment of the present invention.

As shown in FIG. 2, the content converting system according to the present invention includes detailed modules 201 to 209 for performing operations of a preprocessing step (S1), a web document analyzing step (S2), a web document converting step (S3) and a web document generating step (S4).

The preprocessing step (S1) is performed in a preprocessor 201 and a client profile analyzer 202. The preprocessor 201 standardizes a non-standard web document including an erroneous tag to output the standardized web document in a data format suitable for analysis. The client profile analyzer 202 performs a reception function of client information. The client information can be included in a HTTP Header fielder for transmission or can utilize a specific communication protocol for transmission. Besides, an input/output management with an external module is performed in the preprocessing step (S1).

In the web document analyzing step (S2), a layout-based structure analyzer 203 receives the web document standardized in the preprocessing step (S1), and the web document is set to the content unit piece (component) through a web document analyzing algorithm. An image converter 204 extracts information on an image encoding/decoding procedure and an image size of the web document.

In the web document converting step (S3), a component block extractor 205 performs grouping of the defined content unit piece (component) to similar pieces within a range not exceeding a maximal width (MAX_WIDTH) of a single screen by using information on a client performance and the attribution value of the content unit piece (component). A component block categorizer 206 categorizes each component block into the “index” and “body content” portions depending on the characteristic of the content.

The web document generating step (S4) performs a procedure of generating necessary content objects. An index generator 207 extracts image or text index information from the index-categorized component block, and generates a script file and an additional tag collection for expressing the extracted information. An auditory markup generator 208 performs a converting procedure of a text-centered body content block into a markup language such as voiceXML, etc. so as to perform an auditory supporting function. At this time, a browser should provide a function of rendering the web document of auditory information to sound. Lastly, a customized HTML generator 209 suitably rearranges and re-constructs content object elements generated in an earlier step according to a document pattern to generate a customized web document.

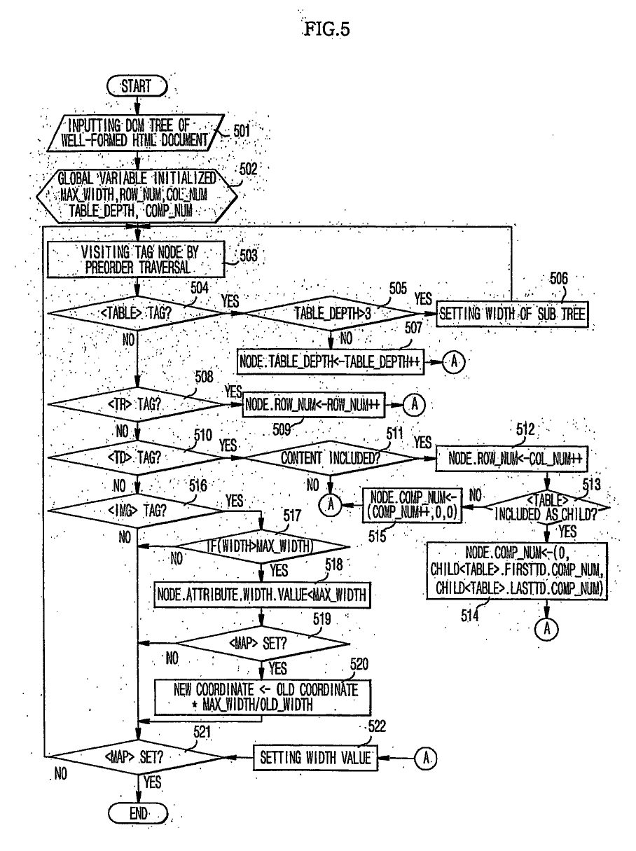

FIG. 4 is a flow chart for describing a total operational procedure of FIG. 2. Referring to the drawings, an original HTML file is inputted to standardize the HTML document, and then a data structure having a HTML DOM tree format is outputted (401 to 403). These steps are performed in the preprocessor 201 module of FIG. 2. In the web document analyzing (HTML tag analyzing) step 404, tree data is inputted to analyze the tag, and this procedure is performed in the structure analyzer 203 and the image converter 204 of FIG. 2. A detailed algorithm of the web document analyzing step 404 will be described below with reference to the flow chart of FIG. 5.

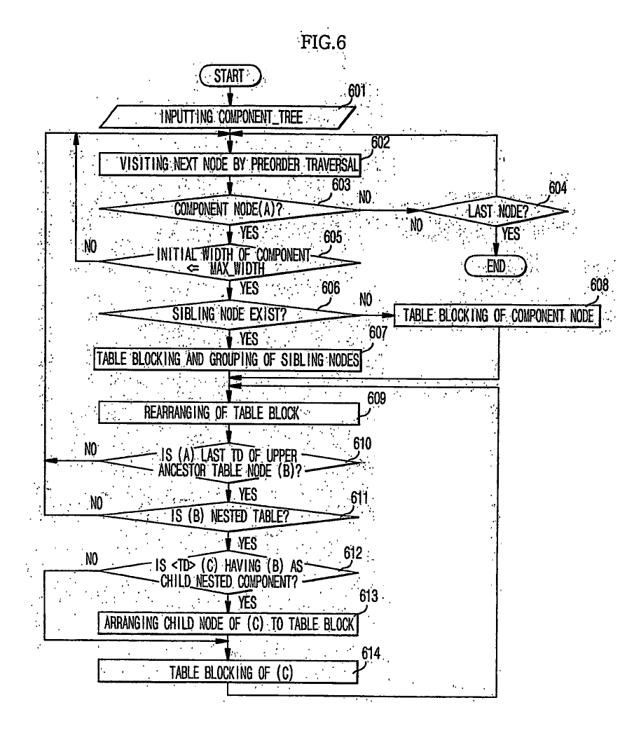

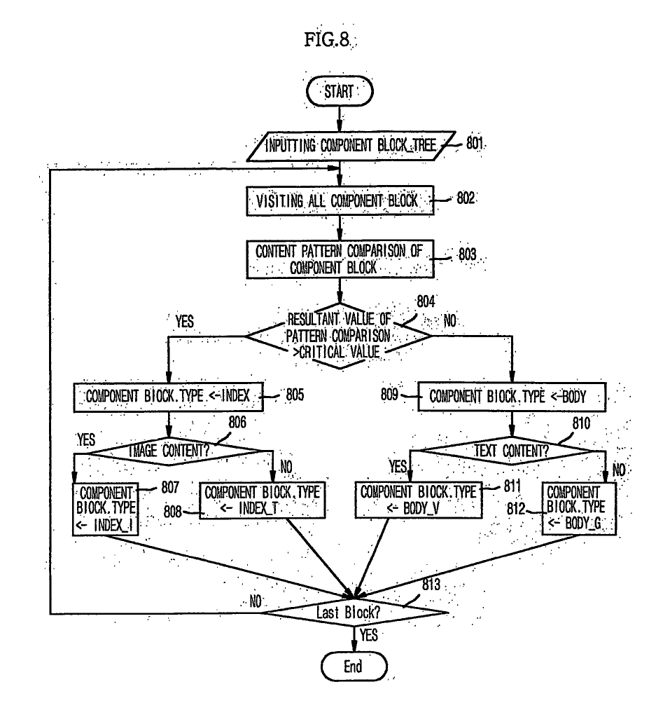

After the tag analyzing step, a component block setting step 405 is performed in the component block extractor 205 of FIG. 2, and a next component block categorizing step 406 is performed in the component block categorizer 206 of FIG. 2. Each of the algorithms of the component block setting step 405 and the component block categorizing step 406 is described with reference to the flow charts of FIGS. 6 and 8.

First, with reference to FIG. 5, a detailed algorithm of the web document analyzing step 404 will be described as follows.

The analysis algorithm of the present invention will be described for the case in which the tags such as <TABLE>, <TR>, <TD>, <IMG>, etc. are mainly used and a specific tag <TD> is defined as the component to be used as a minimal unit of a content unit analysis.

First, a HTML document tree data structure is inputted, and the maximal screen width received through the user device is defined as the maximal width “MAX_WIDTH” (501, 502). In the analyzing procedure, information as in Table 1 is additionally stored in a tag node <TD> and is later used for extraction of the component block.

TABLE 1

| Variable | Content |
|---|---|
| width | Width value being re-calculated in pixel unit |
| Comp_num | Value for expressing ID of component in case of setting |
| | to component |
| | General component: (sequence number, 0, 0) |
| | Nested component: |
| | (0, first number of Comp_num of first child, first number |
| | of Comp_num of last child) |
| Col_num | Number representing at which column to position in layout |
| | of total table structure |
| Row_num | Number representing at which row to position in layout |
| | of total table structure |
| Table_depth | Representing number of ance4stor tag node <Table> |
| | of <TD>, that is depth of nested_table |

After an initialization for a global variable is ended in a step of 502, all of the tag nodes are visited in a preorder sequence while the following procedure are repetitively performed (503).

In case of the visited node being <TABLE> tag (504), the table depth (Table_depth) is checked (505), and in case of the critical value (e.g., 3) being exceeded, the <Table> tag and its all subordinate child nodes are regarded as a general content to perform only a width setting step (506) without any further analysis. In case the table depth (Table_depth) does not exceed the critical value (e.g., 3), a value of the table depth (Table_depth) is increased by one (507).

In case of the visited node being <TR> tag (508), a row number (Row_num) is increased (509). However, in case of the first row of the nested table, the row number is not increased. Further, in case of the <TR> tag of the root table, a column number (Col_num) is initialized by zero.

In case of the visited node being <TD> tag (510); it is determined whether the content is included (511) to increase the column number (Col_num) (512). However, a first <TD> of the nested table <TR> is not increased. The width setting step 522 is performed in case the <TD> does not include the content for use in a layout expression, and the component is set and structural information is added in case the content is included.

That is, the component is defined as <TD> tag block having the content. If the <TABLE> tag is included as a child among the component (513), set is made to the nested component to mark the value of the component number (Comp_num) as shown in Table 1, (514), and in case tags other than the <TABLE> are included as the content, set is made to a general component to define a variable of the component number (Comp_num) as an increased sequence number(515).

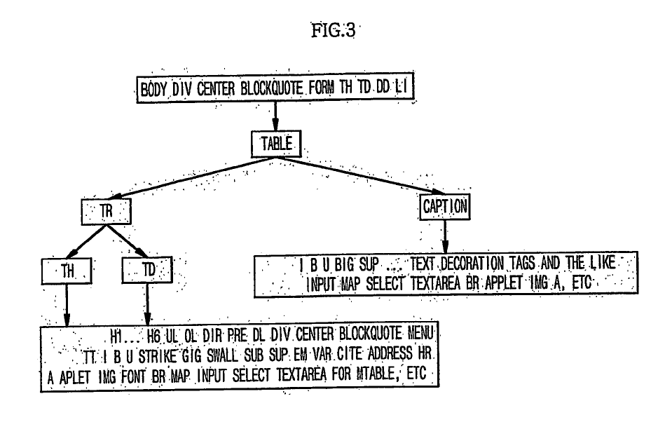

Referring to the expression class relation view of the <TABLE> tag of FIG. 3, a tag kind that can be included in the <TD> tag can be checked. Referring to the drawings, the table is categorized into TR and CAPTION, and the TR is categorized into TH and TD.

In case the visited node is <IMG> (516), the width is checked and then changed (517, 518). If the width is changed, it is checked whether the image map is set. If the image map is set, a COORDS attribution value of an image map code <AREA> representing a coordinate value is modified using a formula of 520. In the width setting procedure of the step 518, a %-set value is exchanged into a pixel, the width is substituted with the maximal width (MAX_WTH) in case the width exceeds the maximal width (MAX_WIDTH), and an analogy is made using the <TR> width, a sum of the <TD> width and a maximal <IMG> width, etc. if the width attribution value is not set.

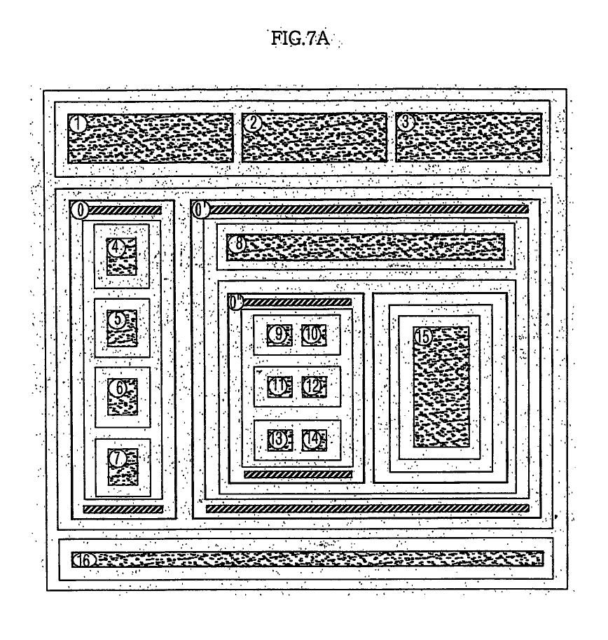

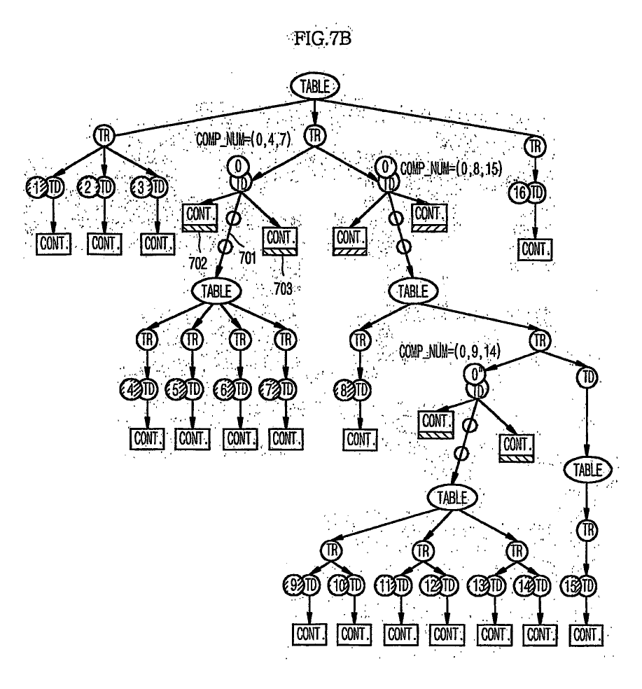

FIGS. 7A and 7B are exemplary view for describing the web document analyzing step and the component block extracting step according to a preferred embodiment of the present invention.

Through an example of FIGS. 7A and 7B, the structural information obtained from the algorithm of FIG. 5 is checked.

In FIG. 7A illustrating the visual expression of the structural tag, the <TABLE>, <TR>, <TD> block are expressed, and the component is set for the <TD> tag block having the content. Additional information is shown in the following Table 2. In FIG. 7B expressing the tag collection as in FIG. 7A in a tree model of the structural tag, the class relation between the tags can be easily understood.

TABLE 2

| (A) | Comp_num | Row_num | Col_num | Table_depth | Width |
|---|---|---|---|---|---|
| \textcircled{1} | (1, 0, 0) | 1 | 1 | 1 | 200 |
| \textcircled{2} | (2, 0, 0) | 1 | 2 | 1 | 400 |
| \textcircled{3} | (3, 0, 0) | 1 | 3 | 1 | 200 |
| ⊚ | (0, 4, 7) | 2-5 | 1-1 | 1 | 150 |
| \textcircled{4} | (4, 0, 0) | 2 | 1 | 2 | 150 |
| \textcircled{5} | (5, 0, 0) | 3 | 1 | 2 | 150 |
| \textcircled{6} | (6, 0, 0) | 4 | 1 | 2 | 150 |
| \textcircled{7} | (7, 0, 0) | 5 | 1 | 2 | 150 |
| ⊚′ | (0, 8, 15) | 2-5 | 2-4 | 1 | 650→ |
| | | | | | MAX_WIDTH |
| \textcircled{8} | (8, 0, 0) | 2 | 2 | 2 | 650→ |
| | | | | | MAX_WIDTH |
| ⊚″ | (0, 9, 14) | 3-5 | 2-3 | 2 | 400 |
| \textcircled{9} | (9, 0, 0) | 3 | 2 | 3 | 200 |
| \textcircled{10} | (10, 0, 0) | 3 | 3 | 3 | 200 |
| \textcircled{11} | (11, 0, 0) | 4 | 2 | 3 | 200 |
| \textcircled{12} | (12, 0, 0) | 4 | 3 | 3 | 200 |
| \textcircled{13} | (13, 0, 0) | 5 | 2 | 3 | 200 |
| \textcircled{14} | (14, 0, 0) | 5 | 3 | 3 | 200 |
| \textcircled{15} | (15, 0, 0) | 3 | 4 | 3 | 250 |
| 16 | (16, 0, 0) | 6 | 1 | 1 | 800→MAX_WIDTH |

In the above Table 2, (A) is the first number of the component number (Comp_num) indicated in FIGS. 7A and 7B, and it is assumed that the maximal width (MAX_WIDTH) is below 500 pixels.

Next, the component block bundles all of the tag collections included therein with reference to the component unit by a single <TD> of a separate <TABLE> tag to be inserted into the same position as the upper ancestor <TABLE> for creation.

With reference to FIG. 6 and FIG. 7B, the detailed algorithm of the component block setting step (405) will be described as follows.

First, the component tree (Component_tree) is inputted to check information on an initial width of all component nodes, and then the following procedure is performed when the maximal width (MAX_WIDTH) is exceeded (601-604). It is determined whether there is a sibling node of the current component node (A), and then if there is the sibling node, a grouping procedure is performed for bundling similar sibling nodes within the range of not exceeding the maximal width (MAX_WIDTH) (605-607). In the example of FIG. 7B, the component of \textcircled{1}, \textcircled{2}, \textcircled{3} can be made to a group (\textcircled{1}),(\textcircled{2}),(\textcircled{3})) or (\textcircled{1}\textcircled{3}), (\textcircled{2}).

In the following table blocking step (608), all tag collection belonging to each of the groups are expressed as one table block in a format such as “<TABLE><TR>Component \textcircled{1},\textcircled{3}/<TR></TABLE>”. Or, if there is no sibling node, only the table blocking procedure of the component node is performed in the step 608.

In the table block rearranging step of the step 609, the table block newly generated in an upper procedure is inserted into a previous sibling node of the <TABLE> node (B) as the grandparent node of the (A).

If the (A) is the last <TD> node of the (B) (610) and the (B) is the nested table (611), a next step is performed (612), and otherwise, a next node is visited to repetitively perform earlier procedure in a step 602.

The next step is performed when the \textcircled{7}, \textcircled{14}, \textcircled{15} of FIG. 7B are the (A), that is, the component being currently visited. In case the upper ancestor <TD> having the (B) as the child, that is, the (C) is the nested component, the step 609 is performed. In other words, the \textcircled{7}, \textcircled{14} of FIG. 7B and each of the (C) becomes ⊚ and ⊚″. With reference to the child node (701 of FIG. 7B) including the (B) among the child nodes of the (C), all sibling nodes at left and right sides are bundled by each of the table blocks (702, 703 of FIG. 7B). Again, the table block including the (C) is generated (614), and the step 609 is repetitively performed.

The component is extracted as one expression unit through the table blocking, and the extracted component is defined as the block. Each of the component blocks has an arrangement sequence determined according to a position of the component on the tree, and is expressed in a shape of a table block, up to down depending on the sequence.

Referring continuously to FIG. 8, the detailed algorithm of the component block categorizing step 406 will be described.

The component block tree is inputted to visit all component blocks while the content pattern of the component block is compared (801-803). At this time, a usable comparative variable is arranged in the following Table 3.

TABLE 3

| Variable | Expected pattern |
|---|---|
| Text_Length | Similar repetition, limited short length |
| Image_Width | Similar repetition, limited width |
| Link_Number | Almost all contents have link information. Comparing |
| | position o [symbol] connected document, similarity of file name |
| Row_num | Limiting to small number. Limiting to block arranged at |
| | upper stage i [symbol] web document |
| Col_num | Limiting to maximal or minimal value. Limiting to block |
| | arranged at lef [symbol] or right side. |

Depending on whether or not a result value of the pattern comparison exceeds a certain critical value, the index type (INDEX type) is determined (804, 805). The component block determined as the index (INDEX) respectively sets a type value to an image index (INDEX_I) and a text index (INDEX_T) (806-808) depending on whether data type of the content thereof is the image or text.

The block not being the index (INDEX) is categorized as the body (BODY), and is categorized as a voice body (BODY_V) type for converting into a voice supportable document and a general body (BODY_G) processed as other general content blocks according to a relative importance of the text to the content included (809-812). In case of not being the last block in the step 813, a procedure is performed starting from the step 802 for the next block.

The after-categorization procedure will be described with reference to the flow chart showing a total operational procedure of FIG. 4.

Referring to the drawings, after the component block is categorized (407-409, 412), the steps 411, 413, 414 of FIG. 4 are performed or the component block is well extracted (410) according to the type of each component block. This procedure is performed for all component block (415), and each of the blocks are suitably arranged in the last step 416 to generate a new HTML document (417). An operation procedure by the type of the component block will be described as follows.

If the type of the component block is the voice body (BODY_V)(Type—BODY_V), the voice document generating step (411) is performed to generate the voice supporting document. This is performed in the voice markup generator 208 module of FIG. 2, and all text portions can be added as the <prompt> value as in a sample code of the following Table 4 in the block to generate a simple VoiceXML document. The generated document is stored as a separate file and is connected with a link in an original HTML.

```
TABLE 4
  <?xml version=“1.0”?>
  <vxml version=“1.0”>
  <form>
    <block>
      <prompt>
      (Adding text information extracted from Blcok categorized as
BODY_V, to value)
      </prompt>
      <disconnect/>
    </block>
  </form>
  </vxml>
```

Herein, if the type of the component block is the general body (BODY_G)(Type=BODY_G) it is extracted well for rearrangement due to the general content element.

If the type of the component block is the image index (INDEX₋I)(Type=INDEX_I), the image index (Image Index) expressed in the Java Script through the image index generating step (413) is generated. As in an example of a sample code of the following Table 5, a simple script file is automatically generated, and the image file is mapped for its embodiment.

```
TABLE 5
  // javascript filled into HEAD
  <SCRIPT LANGUAGE=“JavaScript”>
  <!--
  image1= new Image( );
  image1.src = “image1.gif”;
  image2= new Image( );
  image2.src = “image2.gif”;
  image3= new Image( );
  image3.src = “image3.gif”;
  image4= new Image( );
  image4.src = “image4.gif”;
  links = new Array;
  links[0] = “LINK #1”;
  links[1] = “LINK #2”;
  links[2] = “LINK #3”;
  links[3] = “LINK #4”;
  function imgchange( ){
    var imageNum = document.form.selImage.selectedIndex + 1;
    fname = eval(“image” + imageNum + “.src”);
    document.img.src = fname;
  }
  function go( ){
    location = links[document.form.selImage.selectedIndex];
  }
  function showlink( ){
    window.status = links[document.form.selImage.selectedIndex];
  }
  //-->
  </SCRIPT>
  // form tag filled into BODY
  <FORM name=“form”>
  <SELECT NAME=“selImage” size=1 onChange=“imgchange( );”>
  <OPTION>Index 1
  <OPTION>Index 2
  <OPTION>Index 3
  <OPTION>Index 4
  </SELECT>
  </FORM>
  <a href=“” onClick=“go( ); return false;” onMouseOver=“showlink( );
return true;” onMouseOut=window.status=“; return true;”>
  <IMG SRC=“image1.gif” NAME=“img” border=0></a>
```

Herein, the type of the component block is the text index (INDEX_T)(Type=INDEX_T), the index information is expressed as the text and is re-expressed using the <select> tag as shown in the following Table 6 through the text index generating step 414. The image index generating step (413) and the text index generating step (414) are performed in the index generator 207 module of FIG. 2, and the index information can be extracted in a general manner.

```
TABLE 6
  // javascript filled into HEAD
  <script language=“JavaScript”>
  <!--
    function change(form){
      var list=form.selectedIndex;
      location type=form.options[list].value;
  // location type is selected among the followings
  // - self.location.href : linking to frame belonging to oneself
  // - top.location.href : all screen is changed irrespective of frame
  // - Parent.location.href : parent frame including oneself is changed
  // - parent.framename.location.href : linking to child frame having
selected name among parent frames
      form.selectedIndex = 0;
    }
  //-->
  </script>
  // form tag filled into BODY
  <form name=“formname” method=“get”>
    <select name=“form”
    onchange=“change(document.formname.form)”>
      <option selected>index List</option>
      <option value=“link #1”>index 1</option>
      <option value=“link #2”>index 2</option>
      <option value=“link #3 ”>index 3</option>
    </select>
  </form>
```

After each component block is expressed in an appropriate method according to the content characteristic as described above, the content object is arranged and generated through the new HTML constructing and generating step 416 performed in the HTML generator 209 of FIG. 2. The sample code of the following Table 7 provides a tag construction of a total HTML and a simple arranging method of each content object.

```
TABLE 7
  <HTML>
  <HEAD>
  <TITLE></TITLE>
  <SCRIPT> --> enclosing script file automatically generated by
Java Script Generator module.
  This is added in case Image Index is generated.
  </SCRIPT>
  </HEAD>
  <BODY> --> Attaching Component Block categorized into
INDEX_T or BODY_G into BODY tag.
  <SELECT>
  <OPTION> --> generating select list form as many as Text Index
and arranging respective values with Option tag.
    </SELECT>
  <TABLE>
  <TR>
  <TD> --> arranging including each of Component Blocks
categorized into BODY_G as value of TABLE TD. At this time, width
of total table newly generated is determined according to display
performance information represented in client profile.
  <IMG src=“speaker.gif”/><A href =“***.xml”> listening to content
(Title) </A> --> connect BODY_V block converted into VoiceXML.
  </TD>
  </TR>
  </TABLE>
  </BODY>
  </HTML>
```

The inventive content converting system as described above can be put on three layers of a web server, a client, and a proxy, and respectively has merits and demerits depending on its environment. Further, the extraction algorithm of the component and the component block can be embodied in various methods, and further, an index generating and voice document generating method is exemplified as one of several embodying methods.

FIGS. 9A and 9B are exemplary view illustrating a converting result of the web content according to a preferred embodiment of the present invention.

FIG. 9A illustrates a resultant page of the web document converted through the rearrangement of the content unit object and the index extraction, and FIG. 9B illustrates a resultant page representing in case the voice supporting markup creating function is added to the resultant page of FIG. 9A.

### INDUSTRIAL APPLICABILITY

As described above, the present invention provides a new technique and system so that the web document prepared to be suitable for the display performance of the existing general desktop personal computer is converted to be effectively expressed even on the small display in case the user of the small display device intends to use a web service by connecting a wireless internet. According to the present invention, the web document is set to the content unit piece by analyzing the structural tag information, and is bundled into a similar content unit group and then categorized into the index or body content on basis of the content information for rearrangement such that a function of browsing with a convenient interface without left and right scrolling for a total web page is provided. Further, the extraction and the generation of the index and the converting of the voice supporting web document are also provided together to provide various reconstructions of the web document and an expression effect considering the characteristic of the small device. Further, an effect can be also obtained for maintaining the content of the original document to the maximum for clarifying a meaning delivery.

It will be apparent to those skilled in the art that various modifications and variations can be prepared in the present invention. Thus, it is intended that the present invention covers the modifications and variations of this invention provided they come within the scope of the appended claims and their equivalents.

1. A web content converting system for converting a large display screen web document into a small display screen web document, the system comprising:
a preprocessor for standardizing non-standard web document having an erroneous tag to output the standardized web document in a data format suitable for analysis;
a client profile analyzer for extracting and managing client information;
a structure analyzer for receiving the web document standardized in the preprocessor to set the web document to a content unit piece (component) according to a document analysis algorithm;
an image converter for extracting information on and image encoding/decoding procedure and an image size included in the web document;
a component block extractor for grouping the set content unit piece (component) to similar groups within a range not exceeding a maximal width by using an attribution value of the content unit piece (component) and client performance information;
a component block categorizer for categorizing each of component blocks generated by the component block extractor into index and body content portions in accordance with a content characteristic;
an index generator for extracting information on image or text index from the component block categorized into the index portion, and generating a script file and an additional tag collection for expressing the extracted information;
a voice markup generator for converting a text-centered body content block into a voice markup language to perform a voice supporting function; and
a HyperText Markup Language (HTML) generator for rearranging and reconstructing the generated content object elements according to a document pattern to generate the small display screen web document.

2. The web content converting system of claim 1, wherein the web content converting system is installed at any one of three layers of a web server a client and a proxy.

3. A web content converting method for converting a large display screen web document into a small display screen web document, the method comprising:
a preprocessing step for standardizing a non-standard web document including an erroneous tag to output the standardized web document in a data format suitable for analysis;
a web document analyzing step for receiving the standardized web document and analyzing a tag according to a document analysis algorithm to set the web document to a content unit piece (component);
a component block setting step for grouping the set content unit piece (component) to similar groups within a range not exceeding a maximal width by using an attribution value of the content unit piece (component) and client performance information;
a component block categorizing step for categorizing each of component blocks generated by the component block extractor into index and body content portions in accordance with a content characteristic;
an index generating step for extracting information on image or text index from the component block categorized into the index portion, and generating a script file and an additional tag collection for expressing the extracted information;
a voice markup generating step for converting a text-centered body content block into a voice markup language to perform a voice supporting function; and
a HyperText Markup Language (HTML) generating step for rearranging and reconstructing the generated content object elements according to a document pattern to generate the small display screen web document.

4. The web content converting method of claim 3, wherein in the web document analyzing step, a tag such as <TABLE>, <TR>, <TD>, <IMG>, etc. is mainly analyzed, and a specific <TD> tag is defined as a component to be used as a minimal unit for the content unit analysis.

5. The web content converting method of claim 3, wherein in the component block setting step, a component tree is inputted to check initial width information for all component nodes, and it is checked whether or not a sibling node of a current component node exists, and if existing, similar sibling nodes are bundled and grouped within the range not exceeding the maximal width (MAX_WIDTH).

6. The web-content converting method of claim 3, wherein the component block categorizing step comprises the steps of:
receiving a component block tree to visit all component blocks while to compare a content pattern of the component block;
determining an index type if a resultant value of the pattern comparison exceeds a certain critical value;
setting a type of the index-determined block to each of an image index (INDEX_I) or a text index (INDEX_T) depending on whether a data type of the content is an image or a text; and
categorizing the block not being the index into the body, and categorizing the voice body (BODY_V) for performing the converting into the voice supporting document and the general body (BODY_G) processed as other general content blocks.
